(19) United States
(12) Patent Application Publication
(10) Pub. No.: US 2008/0042979 A1
(43) Pub. Date: Feb. 21, 2008

(54) Method and apparatus for executing commands or inputting data based on finger's characteristics and Multi-Finger key

(76) Inventor: NAVID NIKBIN, Tehran (IR)

Correspondence Address: BARRY CHOOBIN, 193 SUITE #18, TALEGHANI, BAHARE SHOMALI, TEHRAN, 1563714311, omitted

(21) Appl. No.: 11/840,971

(22) Filed: Aug. 19, 2007

(51) Int. Cl. G06F 3/02

(52) U.S. Cl. 345/168

(57) ABSTRACT

The present invention uses a key to produce more than one action based on the finger which has pressed or touched the key. By knowing which finger has acted on the key the present invention takes different actions, executes different commands or inputs different data. So by using multi-finger keys the present invention reduces the total number of keys needed for a particular set of actions.

### FIELD OF THE INVENTION

The present invention generally relates to the field of user input devices. More specifically it relates to inputting commands and/or data to a device.

### BACKGROUND OF THE INVENTION

To enter data to a device such as a desktop computer, a laptop or a mobile phone a keyboard is usually used. A keyboard contains a set of keys in which pressing each single-key, a combination of keys or a sequence of keys usually corresponds to issuing a command or entering a predefined data. Also an electrical or electronic device such as a camera, a dish washer or a television usually contains some keys with predefined functionality. In each of these devices, by considering which key is pressed, and maybe by considering the current state and/or the configuration of the device, a predefined action is performed or a predefined data is entered.

It must be mentioned that the keyboard or the keys may be physical or virtual. Physical keys are those that have a physical body and usually they operate by pressing or touching them. Virtual keys are usually displayed on touch-screen displays but they may be displayed on a surface by projecting a picture on the surface. Also they may have not been shown at all and only being corresponded to a special coordinates. The device must somehow detect pressing or touching these virtual keys.

One of the most widely used devices for entering data and commands into a computer or a handheld device is the keyboard. As the size of electronic devices and computers is shrinking, the dimensions of the input devices—especially keyboards—cannot be reduced too much without a loss of functionality. In many handheld devices, having full keyboard functionality is essential, so sometimes a full physical keyboard is integrated into a small area of these devices. Typically this means that the keys are small and closely spaced and using these keyboards is tedious. Sometimes for reducing the number of keys, single-key functionality is accessed through complex key combinations. Also sometimes more than one input data is assigned to a single key and for example in order to enter a single character; the key may need to be pressed more than one time.

### SUMMARY OF THE INVENTION

The present invention enables a user to use a single key for entering different commands or different data. By using the present invention, the entered command or data is not only related to the pressed or touched key, but also it is related to the finger that acted on the key. So, for a single key, pressing or touching the key by different fingers means issuing different commands or entering different data. We name theses special keys multi-finger keys.

When we use multi-finger keys, we have two parameters which show an action: the key identifier and the active finger identifier. So by considering h hands (h=1 or 2) and considering f fingers for each hand (f=1 to 5) and considering k keys (k≧1) we can produce up to h*f*k different action codes.

For implementing multi-finger keys or keyboards containing multi-finger keys, the most important thing to consider is about how we can identify which finger(s) has pressed or touched the key(s). There are different ways to identify the fingers.

One way to identify the fingers is using special keys which have fingerprint scanners. By touching theses keys, the fingerprint of the pressed key is captured and an event rises for the recognition of the fingerprint. The fingerprint recognition result is combined as finger-id by the key-id to produce the final command or data. This solution usually requires that the fingerprint samples of different fingers of the user or users to be learned to the system.

Another solution is using image processing and computer vision methods for recognition of the finger which has pressed or touched the key. By using a camera we can capture the image of the key (or keys or the keyboard) along with a partial or full picture of the user's hand and analyze the picture by using image processing and/or machine vision methods to find which finger has acted on the key. We can also use stereo vision, laser scanners or sensors which capture three-dimensional positional information to produce the three-dimensional information about the scene and the user's hand, and then use this information to recognize the active finger. Instead of using cameras which operate by visible light, we can use special sensors or cameras which operate by infra-red light. We can also use electrical signals of fingertips for identifying fingers. Instead of using a single camera, we can also use multiple cameras.

In all of above mentioned solutions, we can distinguish between different hands or treat them the same or use only one hand.

### BRIEF DESCRIPTION OF THE DRAWINGS

FIG. 1A shows a rectangular Multi-Finger key used as the control keys of a music player in which five different functionalities of a music player are assigned to the five fingers;

FIG. 1B shows a circular Multi-Finger key used as the control keys of a music player in which five different functionalities of a music player are assigned to the five fingers;

FIG. 1C shows a rectangular Multi-Finger key used for inputting five different characters (a, b, c, d, and e);

FIG. 1D shows a circular Multi-Finger key used for inputting five different characters (a, b, c, d, and e);

FIG. 2 shows a schematic plan view of a keyboard using Multi-Finger keys for inputting alphanumeric data;

FIG. 3 shows another schematic plan view of a keyboard using Multi-Finger keys for inputting alphanumeric data.

FIG. 4 shows the selection of an alphanumeric Multi-Finger key by the thumb finger of a user.

FIG. 5 shows the selection of an alphanumeric Multi-Finger key by the middle finger of a user.

FIG. 6 shows the selection of an alphanumeric Multi-Finger key by the index finger of a user.

FIG. 7 shows the selection of a media controller Multi-Finger key by the middle finger of a user.

FIG. 8a shows the selection of a document icon implemented as a Multi-Finger key by the middle finger of a user;

FIG. 8b shows the selection of a menu item implemented as a Multi-Finger key by the index finger of a user;

FIG. 9 shows a schematic plan view of a cell-phone which it's keypad uses Multi-Finger keys.

### DETAILED DESCRIPTION OF THE INVENTION

The present invention discloses a Multi-Finger key system. A Multi-Finger key is a special multifunctional key which can be used for executing different commands or entering different data based on the finger which has pressed or touched the key. The present invention provides a system with multifunctional behavior which reduces the number of keys on a keyboard and hence the area of each key can be increased.

In the present invention multiple commands or data are assigned to each Multi-Finger key. The present invention discloses a method for executing different commands or entering different data comprising steps of: (i) selecting a key wherein said key comprises of a plurality of executable commands and/or data (ii) Pressing or touching said key with a finger; (iii) Identify said finger from a group comprising of thumb finger, index finger, middle finger, ring finger, and little finger; (iv) Selecting data and/or executable command based on at least said identified finger and at least one of said plurality of executable commands and/or data associated with said key; and (v) executing said executable command and/or processing said data.

The present invention may be better understood with reference to the drawings and the accompanying description.

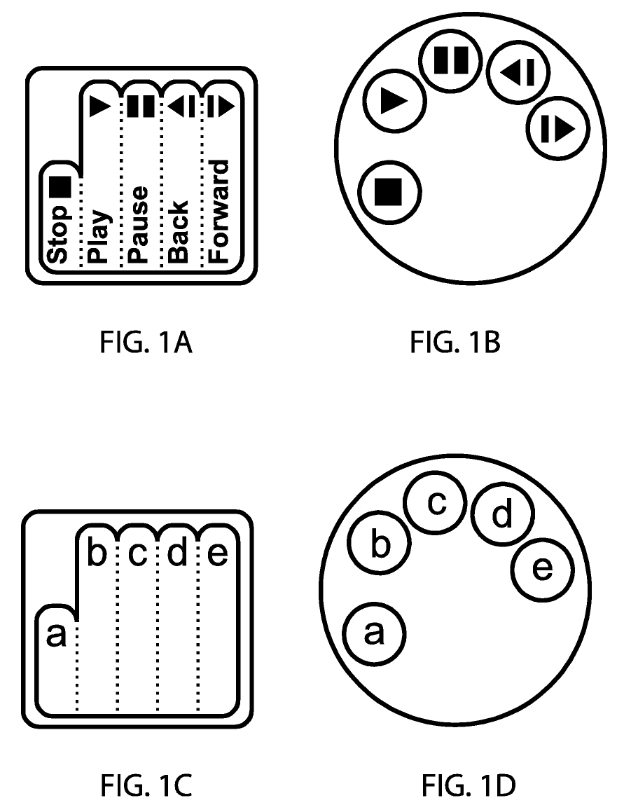

Referring now to the drawings, FIGS. 1A-1D illustrates the schematic view of some Multi-Finger keys.

FIGS. 1A and 1B show a rectangular and a circular Multi-Finger key used as the control keys of a music player in which five different functionalities of a music player are assigned to the five fingers. When said keys are pressed by the thumb finger, the Stop command is executed. When said keys are pressed by the index finger, the Play command is executed. When the keys are pressed by the middle finger, the Pause command is executed. When they are pressed by the ring finger, the Back command is executed. And finally when they are pressed by the little finger, the Forward command is executed.

FIGS. 1C and ID show a rectangular and a circular Multi-Finger key used for entering characters ‘a’, ‘b’, ‘c’, ‘d’ and ‘e’. When these keys are pressed by the thumb finger, the ‘a’ character will be entered. When they are pressed by the index finger, the ‘b’ character will be entered. When they are pressed by the middle finger, the ‘c’ character will be entered. When they are pressed by the ring finger, the ‘d’ character will be entered. And finally when they are pressed by the little finger, the ‘e’ character will be entered.

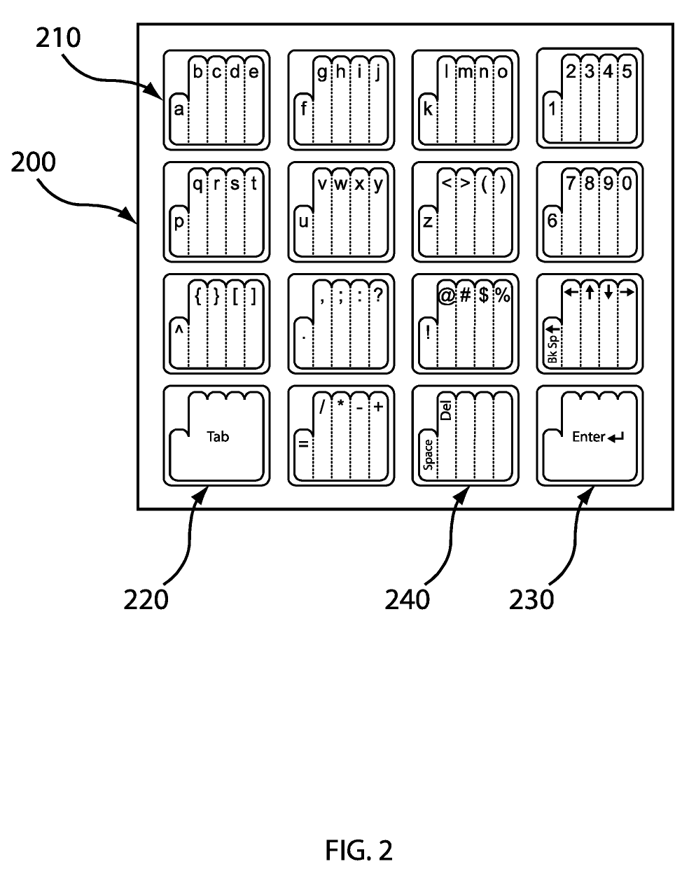

FIG. 2 shows a keyboard 200 containing sixteen Multi-Finger keys for entering different characters. The alphabetic keys are sorted arbitrarily. There are a group of five characters (‘a’, ‘b’, ‘c’, ‘d’ and ‘e’) which are assigned to Multi-Finger key 210. Key 220 is a special key which operates as the Tab key and because there is only one command assigned to this key, we can use an ordinary key instead of a Multi-Finger key for it or we can use a Multi-Finger key which is operating in single-function mode. Likewise, the Key 230 is the Enter key and has only one command assigned to it. Key 240 is a Multi-Finger key which has only two characters assigned to it. When the user presses or touches the key 240 by his/her thumb finger, the Space character will be entered and when he/she presses or touches the key by his/her index finger, the Del command will be issued.

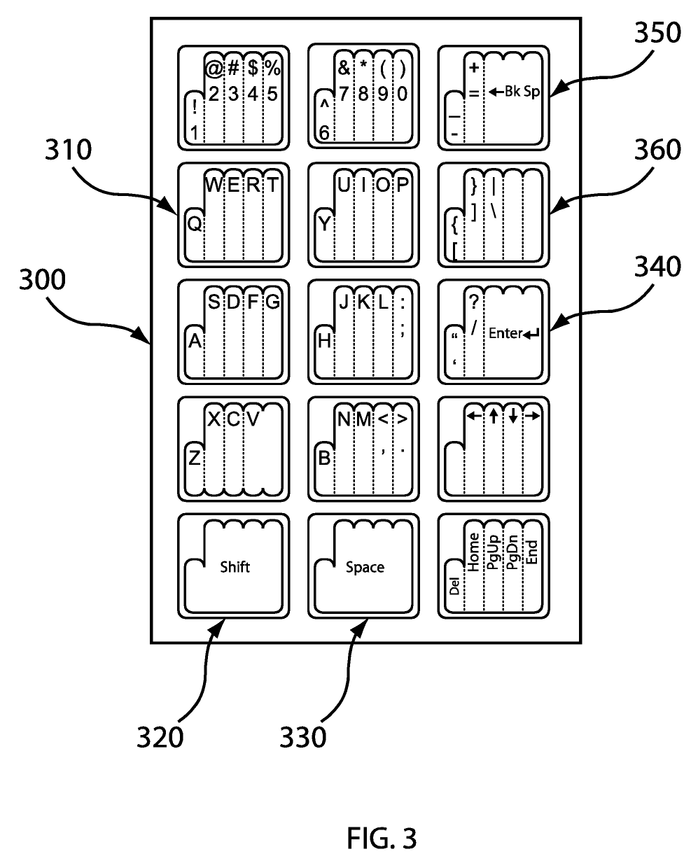

FIG. 3 shows a keyboard 300 which has the layout based on QUERTY keyboard. It also has a Shift key 320 which by pressing it, the keyboard operates in the shifted state and the characters assigned to shift state of the keys will be selected. The key 310 has five lowercase characters assigned to its normal state (‘a’, ‘b’, ‘c’, ‘d’ and ‘e’) and because this key is an alphabetic key, there are also five uppercase characters (‘A’, ‘B’, ‘C’, ‘D’ and ‘E’) assigned to its shifted state. If the user selects the key 310 by his/her thumb, when the Shift state is not enabled the lowercase ‘q’ character will be produced and when the Shift state is enabled by pressing the Shift key 320, the uppercase ‘Q’ character will be produced. Similarly by pressing the key 310 with the index finger the lowercase ‘w’ character or the uppercase ‘W’ character will be produced based on the Shift state. The Shift key 320 can be an ordinary key or a Multi-Finger key operating in single-function mode, because there is only one command assigned to it. Similarly the Space key 330 has only one command assigned to it. The key 340 has 3 different commands assigned to it and also it can operate in shifted-mode. When the key 340 is pressed or touched by the thumb finger of the user, the ‘′’ or ‘″’ character will be selected based on the Shift state. If the key 340 is pressed by the index finger of the user, the ‘/’ character or the ‘?’ character will be selected based on the Shift state. Finally if the key 340 is pressed by the middle finger, ring finger or little finger of the user, the Enter command will be issued. Similarly the key 350 has 3 different commands assigned to it and also it can operate in shifted-mode. When the key 350 is pressed or touched by the thumb finger of the user, the ‘-’ or ‘_’ character will be selected based on the Shift state. If the key 350 is pressed by the index finger of the user, the ‘=’ character or the ‘+’ character will be selected based on the Shift state. Finally if the key 350 is pressed by the middle finger, ring finger or little finger of the user, the Backspace command will be issued. The key 360 has also 3 different commands assigned to it and also it can operate in shifted-mode. When the key 360 is pressed or touched by the thumb finger of the user, the ‘[’ or ‘{’ character will be selected based on the Shift state. If the key 360 is pressed by the index finger of the user, the ‘]’ character or the ‘}’ character will be selected based on the Shift state. Finally if the key 360 is pressed by the middle finger of the user, the ‘\’ or ‘|’ character will be selected based on the Shift state. There aren't any commands associated with the key 360 when it is selected by the ring finger or the little finger of the user.

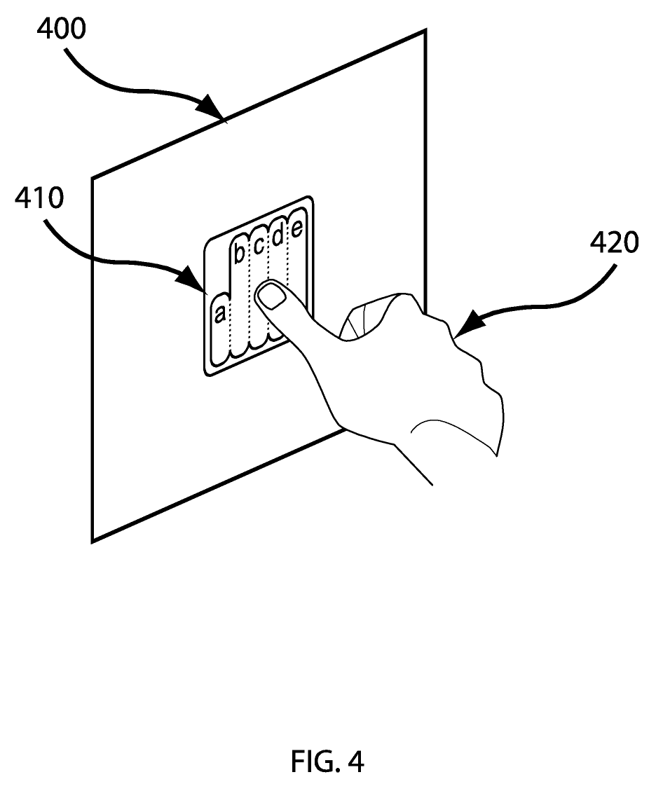

FIG. 4 shows a Multi-Finger key 410 displayed on a touch-screen display 400. A plurality of five characters (‘a’, ‘b’, ‘c’, ‘d’ and ‘e’) is related to the Multi-Finger key. The user selects the key with the thumb finger of his/her hand 420 and therefore the first character which is ‘a’ will be selected.

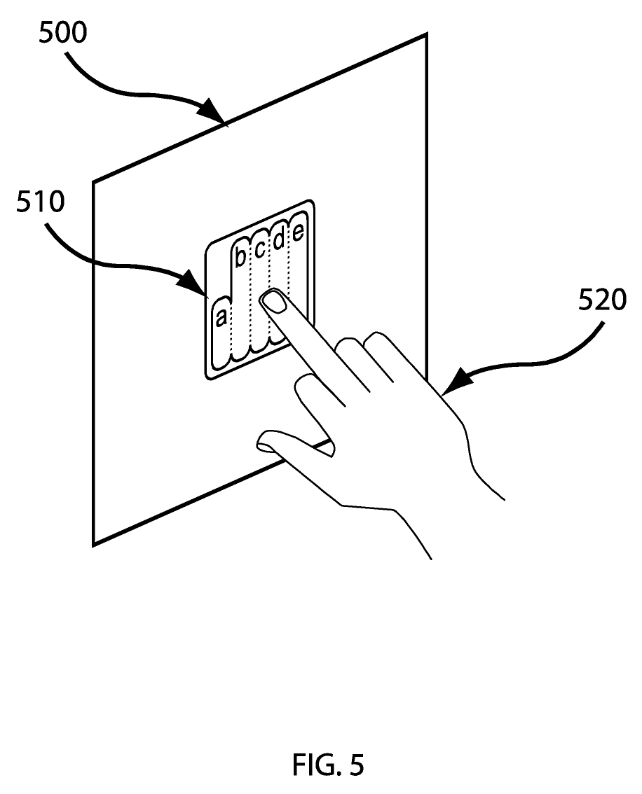

FIG. 5 shows a Multi-Finger key 510 displayed on a touch-screen display 500. A plurality of five characters (‘a’, ‘b’, ‘c’, ‘d’ and ‘e’) is related to the Multi-Finger key. The user selects the key with the middle finger of his/her hand 520 and therefore the third character which is ‘c’ will be selected.

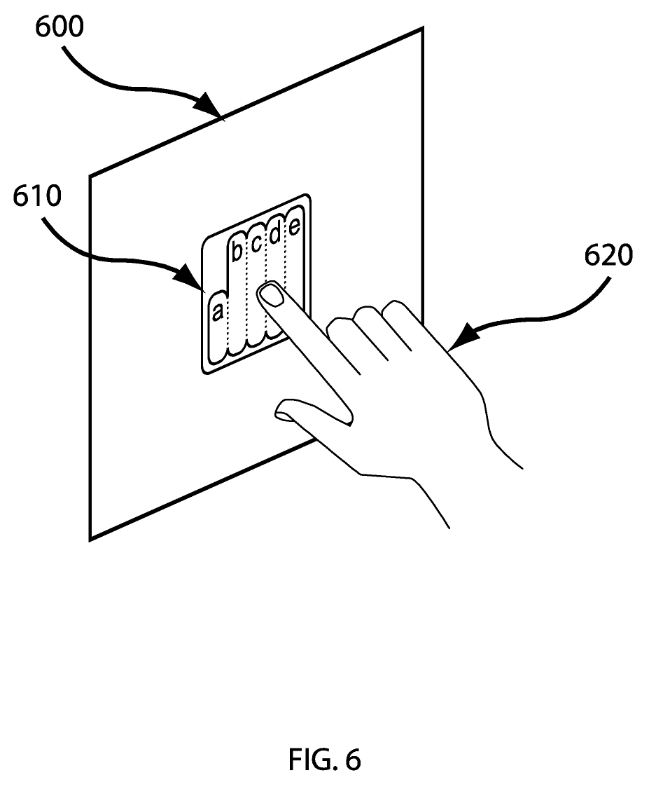

FIG. 6 shows a Multi-Finger key 610 displayed on a touch-screen display 600. A plurality of five characters (‘a’, ‘b’, ‘c’, ‘d’ and ‘e’) is related to the Multi-Finger key. The user selects the key with the index finger of his/her hand 620 and therefore the second character which is ‘b’ will be selected.

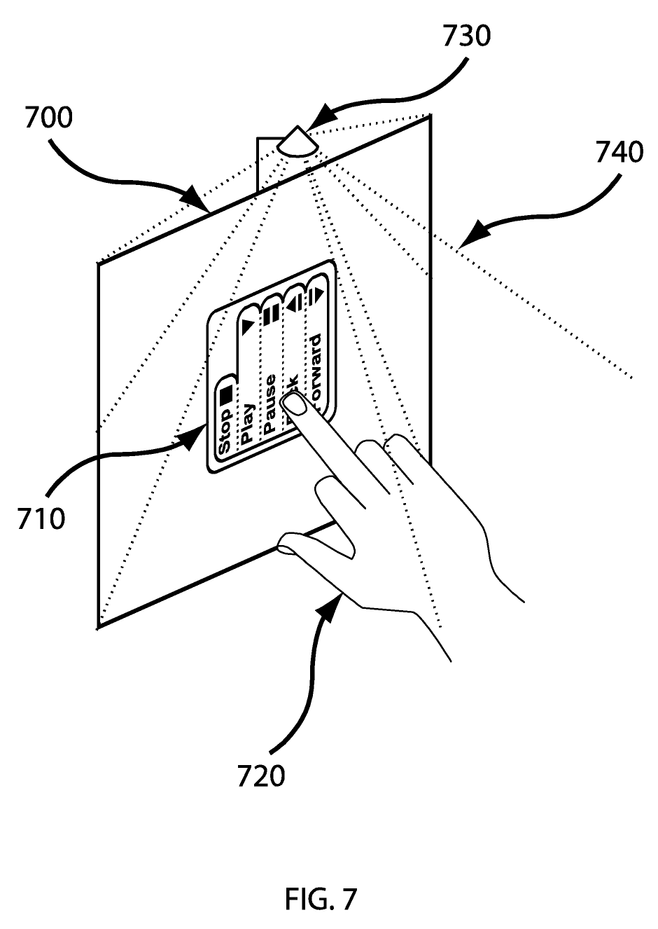

FIG. 7 shows the preferred embodiment of the current invention. This embodiment uses image processing and/or machine vision methods for identification of the finger. A camera 730 with a wide field of view 740 is mounted on top of a touch-screen display 700. A Multi-Finger key 710 is displayed on the touch-screen display 700. A plurality of five commands (Stop, Play, Pause, Back and Forward) is related to the Multi-Finger key. The user selects the key with the middle finger of his/her hand 720. The camera captures the picture of the user's hand and fingers. By analyzing this picture by image processing and/or machine vision methods, the active finger will be identified which in this case is the middle finger. Therefore the third command which is Pause will be executed.

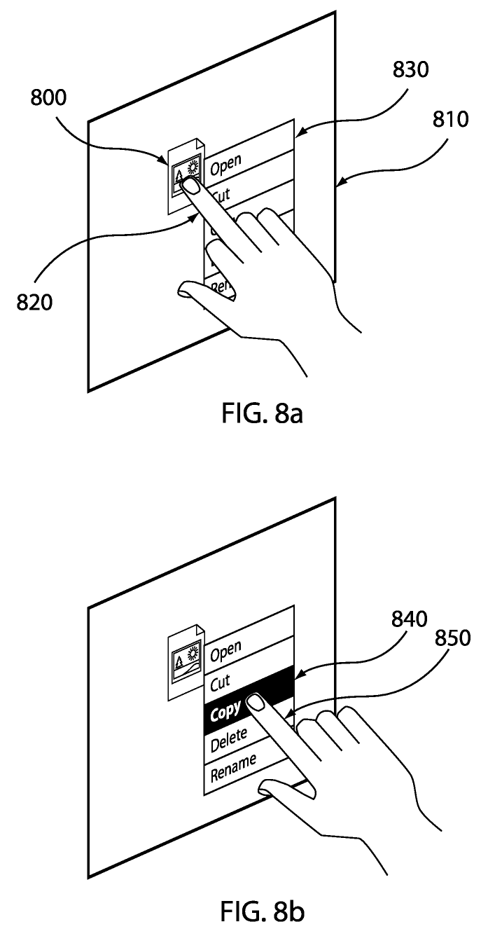

FIGS. 8a and 8b show that clickable element of a graphical user interface can have the Multi-Finger functionality. For example, the present invention simulates the mouse left-clicking and the mouse right-clicking using Multi-Finger keys as shown in FIG. 8a and FIG. 8b.

FIG. 8a in particular shows a document icon 800 being employed as a Multi-Finger key displayed on a touch-screen display 810. Selecting the icon by the middle finger 820 causes a menu 830 to appear on the screen (this is similar to right-clicking on a document icon by a mouse).

FIG. 8b shows the selection of a menu-item 840 being employed as a Multi-Finger key by the index finger 850 of the user (this is similar to left-clicking on a menu-item).

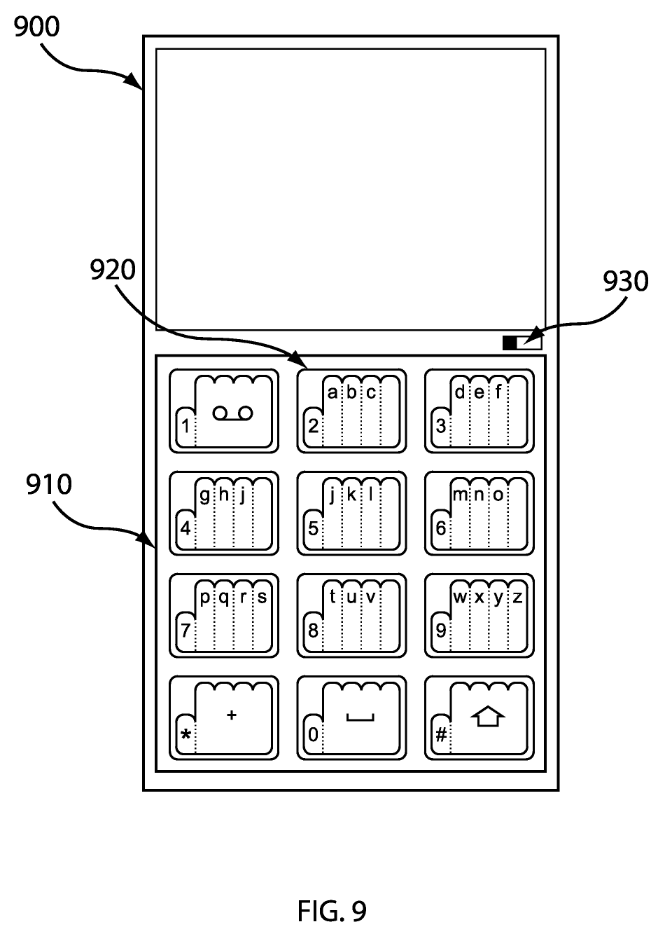

FIG. 9 shows a schematic plan view of a cell-phone 900 which it's keypad 910 uses Multi-Finger keys. The numerical characters are assigned to the thumb finger and the alphabetic characters are assigned to the other fingers. For example by selecting key 920 by the thumb finger, the digit ‘1’ will be entered and selecting the same key by the index finger, causes the letter ‘a’ to be entered. In this keypad, Multi-Finger keys being implemented using the keys equipped by finger-print scanners and using finger-print recognition methods in conjunction with the cell-phone's processor for identifying which finger has touched or pressed the key. The cell-phone can also be equipped by an operation-mode selector key 930 which can be used for switching between single-function mode and multi-function mode. By selecting single-function mode, the keys operate as single-function keys in which selecting the keys by any finger causes the functions assigned as thumb finger functionality of the key to be executed. By selecting multi-function mode, the keys operate as Multi-Finger keys.

The specific arrangements and methods described herein are merely illustrative of the principles of this invention. Numerous modifications in form and detail may be made without departing from the scope of the described invention. Although this invention has been shown in relation to a particular embodiment, it should not be considered so limited. Rather, the described invention is limited only by the scope of the appended claims.

What is claimed is:

1. A method for executing different commands and/or entering different data on a devise comprising steps of:
(i) Selecting a key wherein said key comprises of a plurality of executable commands and/or data;
(ii) Pressing or touching said key with a finger;
(iii) Identifying said finger from a group comprising of thumb finger, index finger, middle finger, ring finger, and little finger;
(iv) Selecting data and/or executable command based on at least said identified finger and at least one of said plurality of executable commands and/or data associated with said key;
(v) And executing said executable command and/or processing said data.

2. The method of claim 1, wherein said key is a physical key.

3. The method of claim 1, wherein said key is related to a region of a touch-sensitive surface.

4. The method of claim 3, wherein said touch-sensitive surface further comprises a touch-sensitive display screen.

5. The method of claim 1, wherein said key is a virtual key related to a virtual input device.

6. The method of claim 1, wherein said identifying step treats any same fingers of two hands of the user in the same manner.

7. The method of claim 1, wherein said identifying step treats any same fingers of two hands of the user in different manner.

8. The method of claim 1, wherein said key is equipped with a fingerprint scanner.

9. The method of claim 1, wherein said identifying step further comprises fingerprinting.

10. The method of claim 1, wherein said identifying step further comprises image processing and/or machine vision for identification.

11. The method of claim 1, wherein said identifying step further comprises detecting electrical signals of fingertips.

12. A computer-readable medium stored thereon computer-executable instructions for performing the method of claim 1.

13. The method of claim 1, wherein said device employs at least one finger for accepting commands from a user.

14. An apparatus for executing different commands and/or entering different data on a device comprising:
(i) means for pressing or touching a key with a finger wherein said key comprises of a plurality of executable commands and/or data;
(ii) means for identifying said finger from a group comprising of thumb finger, index finger, middle finger, ring finger, and little finger;
(iii) means for selecting data and/or executable command based on at least said identified finger and at least one of said plurality of executable commands and/or data associated with said key;
(iv) and means for executing said executable command and/or processing said data.

15. The apparatus as claimed in claim 14, wherein said apparatus further comprises a means for selecting an operational mode, wherein said operational mode consists of a single function operation mode, wherein in said operational mode said apparatus functions independent of the identity and characteristics of the fingers.

16. An apparatus as claimed in claim 14, wherein said apparatus further comprises a modifier, wherein said modifier changes functions of said key in accordance to modifier status.

17. A method as claimed in claim 1, wherein said plurality of executable commands and/or data is assigned dynamically.

18. An apparatus as claimed in claim 14, wherein said apparatus is embedded on a keyboard.

19. An apparatus as claimed in claim 18, wherein keys of said keyboard are arranged alphabetically.

20. An apparatus as claimed in claim 18, wherein keys of said keyboard are arranged QUERTY.

21. An apparatus as claimed in claim 18, wherein keys of said keyboard are arranged arbitrarily.

22. A method as claimed in claim 1, wherein user being informed of selection result of said selecting step via audible feedback or visual feedback.

23. The method of claim 4, wherein said touch-sensitive display screen further comprises at least one clickable user interface element, wherein said at least one clickable user interface element executes at least one command based on characteristics of said identified finger.
